(19) United States
(12) Patent Application Publication
(10) Pub. No.: US 2024/0342813 A1
(43) Pub. Date: Oct. 17, 2024

(54) RECIPROCATING SAW ASSEMBLY

(71) Applicant: MILWAUKEE ELECTRIC TOOL CORPORATION, Brookfield, WI (US)

(72) Inventors: Jacob K. Lindsey, Milwaukee, WI (US); William R. Schlosser, Colgate, WI (US); Matthew R. Wolf, Wauwatosa, WI (US)

(21) Appl. No.: 18/613,806

(22) Filed: Mar. 22, 2024

Related U.S. Application Data
(60) Provisional application No. 63/459,926, filed on Apr. 17, 2023.

(51) Int. Cl. B23D 51/04; B23D 49/00; B23D 49/16

(52) U.S. Cl. CPC B23D 51/04; B23D 49/002; B23D 49/162

(57) ABSTRACT

The present disclosure is directed to a reciprocating saw assembly including a saw unit. The saw unit includes a reciprocating mechanism having a reciprocating spindle to which a saw blade is attachable, a drive unit for providing torque to the reciprocating mechanism, causing the spindle to reciprocate, and an outer housing in which the drive is received. The outer housing includes a handle portion graspable by a user during a cutting operation. The reciprocating saw assembly further includes a clamping unit having a clamp housing pivotably coupled to the outer housing and a jaw movable relative to the clamp housing between a clamping position, in which the clamping unit is affixed to a workpiece to be cut, and a release position, in which the clamping unit is removable from the workpiece.

### CROSS-REFERENCE TO RELATED APPLICATIONS

The present application claims priority to U.S. Provisional Patent Application No. 63/459,926, filed on Apr. 17, 2023, the entire content of which is incorporated herein by reference.

### FIELD OF THE INVENTION

The present invention relates to a reciprocating saw and, more particularly, to a portable, battery powered reciprocating saw.

### BACKGROUND OF THE INVENTION

Reciprocating saws are used to cut a variety of objects made from a variety of materials, such as metal pipes, wood and drywall. Sometimes, reciprocating saws are used with clamping assemblies to secure a workpiece to be cut (e.g., a pipe) to the reciprocating saw to stabilize the reciprocating saw during a cutting operation.

### SUMMARY OF THE INVENTION

The invention provides, in one aspect, a reciprocating saw assembly including a saw unit. The saw unit includes a reciprocating mechanism having a reciprocating spindle to which a saw blade is attachable, a drive unit for providing torque to the reciprocating mechanism, causing the spindle to reciprocate, and an outer housing in which the drive unit is received. The outer housing includes a handle portion graspable by a user during a cutting operation. The reciprocating saw assembly further includes a clamping unit having a clamp housing pivotably coupled to the outer housing and a jaw movable relative to the clamp housing between a clamping position, in which the clamping unit is affixed to a workpiece to be cut, and a release position, in which the clamping unit is removable from the workpiece.

The invention provides, in another aspect, a reciprocating saw assembly including a saw unit. The saw unit includes a reciprocating mechanism having a reciprocating spindle, a saw blade attached to the reciprocating spindle, the saw blade defining a first side and an opposite, second side, a drive unit for providing torque to the reciprocating mechanism, causing the spindle to reciprocate, and an outer housing in which the drive unit is received. The outer housing includes a handle portion graspable by a user during a cutting operation. The reciprocating saw assembly further includes a clamping unit having a clamp housing coupled to a portion of the drive unit housing, a first stationary jaw affixed to the clamp housing adjacent to the first side of the saw blade, a second stationary jaw affixed to the clamp housing adjacent to the second saw blade and first and second movable jaws. The first and second movable jaws are in a facing relationship with the first and second stationary jaws, respectively.

The invention provides, in another aspect, a reciprocating saw assembly including a saw unit. The saw unit includes a reciprocating mechanism having a reciprocating spindle to which a saw blade is attachable and a drive unit for providing torque to the reciprocating mechanism, causing the spindle to reciprocate along a reciprocating axis. The reciprocating saw assembly further includes a clamping unit having a clamp housing pivotably coupled to a portion of the saw unit to be carried therewith, a first stationary jaw affixed to the clamp housing, a second stationary jaw affixed to the clamp housing, first and second movable jaws in a facing relationship with the first and second stationary jaws, respectfully, and a blade slot defined between the first and second stationary jaws, and between the first and second movable jaws. The blade slot defines a plane containing the reciprocating axis.

Other aspects of the embodiments will become apparent by consideration of the detailed description and accompanying drawings.

### BRIEF DESCRIPTION OF THE DRAWINGS

FIG. 1 is a side view of a reciprocating saw assembly in accordance with an embodiment of the invention.

FIG. 2 is a partial cutaway view of the reciprocating saw assembly of FIG. 1.

FIG. 3 is a partial cutaway view of a saw unit of the reciprocating saw assembly of FIG. 1.

FIG. 4 is a cross-sectional view of a portion of the reciprocating saw assembly of FIG. 1 through section 4-4 in FIG. 1.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting.

### DETAILED DESCRIPTION

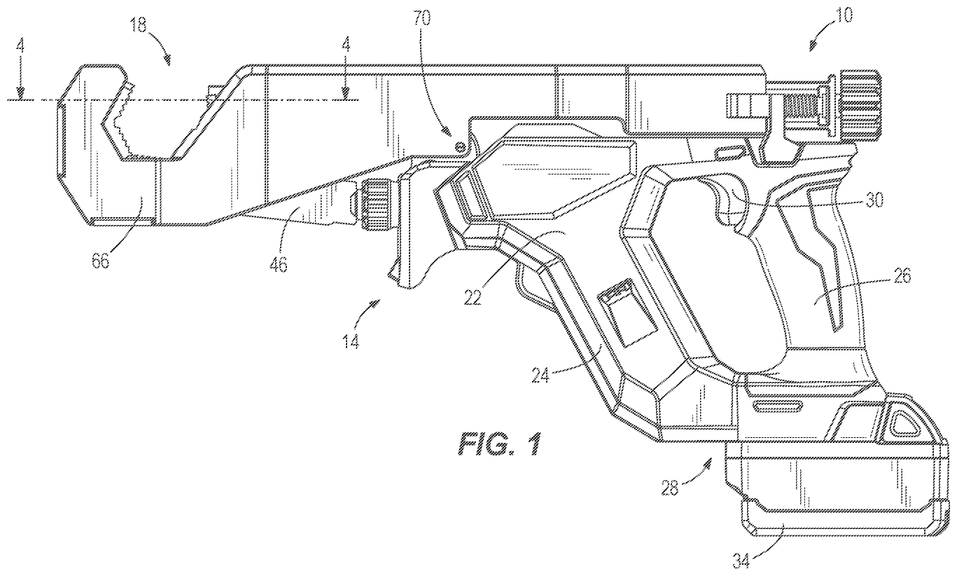

FIG. 1 illustrates a power tool, such as a reciprocating saw assembly 10, including a saw unit 14 and a clamping unit 18. The saw unit 14 includes an outer housing 22 having a motor housing portion 24, a handle portion 26 graspable by a user and extending rearward of the motor housing portion 24, and a battery receptacle portion 28 extending between lower ends of the respective motor housing portion 24 and handle portion 26. The saw unit 14 also includes a trigger 30 protruding from the handle portion 26 to operate the saw unit 14 and a battery pack 34 that is removably connectable to the battery receptacle portion 28.

In the illustrated embodiment, the battery pack 34 is an 18-Volt battery pack. The pack 34 includes a plurality of battery cells (not shown) based on a lithium-ion or other chemistry. The cells of the battery pack 34 may additionally be connected in series, parallel, or some combination thereof. The battery pack may be configured to connect and power a variety of tools in addition to the saw unit 14. In other embodiments, the battery pack 34 may also power the clamping unit 18.

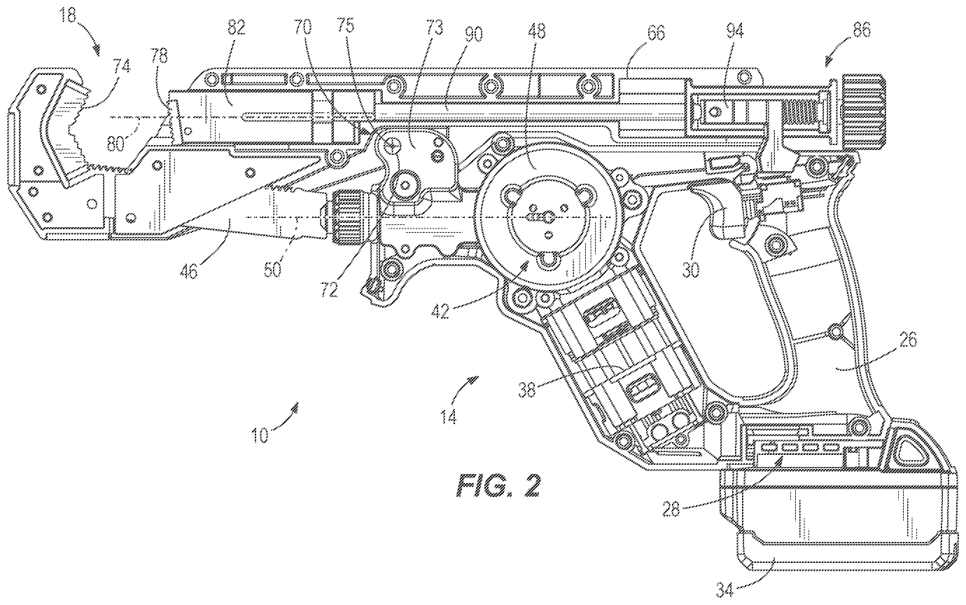

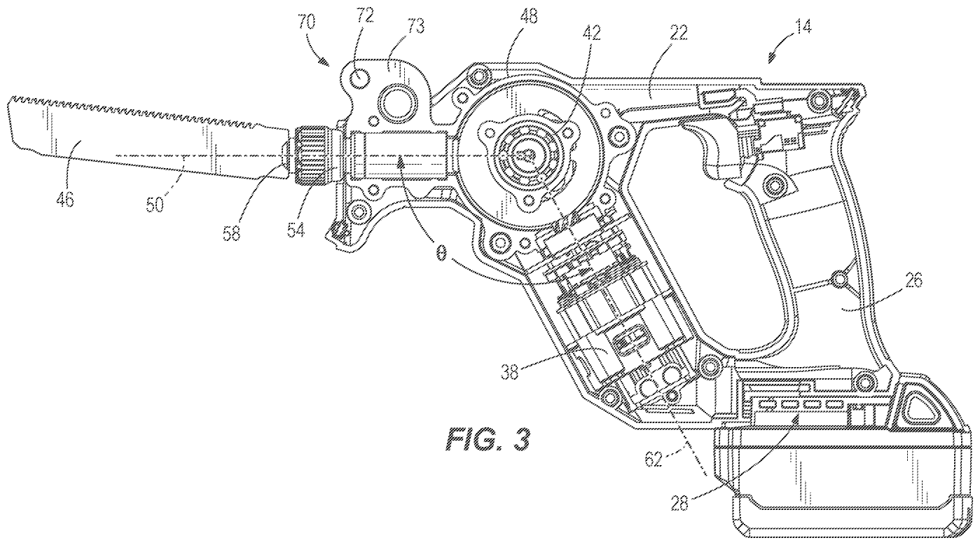

Referring now to FIGS. 2-3, the saw unit 14 includes a drive unit (e.g., an electric motor 38) disposed within the motor housing portion 24. The motor 38 is configured to provide torque to a reciprocating mechanism 42 to reciprocate a saw blade 46 along a reciprocation axis 50. In some embodiments, the reciprocating mechanism 42 includes a scotch yoke mechanism located in an inner housing 48, a reciprocating spindle 54 that defines an output of the reciprocating mechanism 42, and a blade clamp 58 attached to the spindle 54 (FIG. 3). In the illustrated embodiment, the inner housing 48 is separate from the outer housing 22 and is at least partially positioned within the outer housing 22 and affixed thereto. As illustrated, a tool element, such as the saw blade 46, is coupled to the spindle 54 via the blade clamp 58. Accordingly, when the reciprocating mechanism 42 causes the spindle 54 to reciprocate, the coupled saw blade 46 will also reciprocate. In the illustrated embodiment, the saw blade 46 is secured to the blade clamp 58 with the teeth of the blade 46 oriented in an upward direction (i.e., facing the clamping unit 18) and the saw unit 14 is pivoted in a clockwise direction from the frame of reference of FIG. 1, to cut the workpiece from below. In another embodiment, the teeth of the saw blade 46 may face downwards with the clamping unit 18 located below the saw unit 14, requiring the saw unit 14 to be rotated in a counterclockwise direction to cut the workpiece from above.

With reference to FIG. 3, the motor 38 defines a rotational axis 62 that forms an oblique angle θ with the reciprocation axis 50. In other embodiments, the motor 38 may be disposed in a different orientation. For example, the rotational axis 62 may be parallel or perpendicular to the reciprocation axis 50. Additionally, the motor 38 may be disposed in different portions of the housing 22, such as the handle portion 26.

With reference to FIG. 2, The clamping unit 18 includes a clamp housing 66 that is pivotably connected to the saw unit 14 through a pivot joint 70. In the illustrated embodiment, the pivot joint 70 includes a cylindrical pin 72 that defines a pivot axis 75 oriented perpendicular to the reciprocation axis 50 of the spindle 54 and that is pivotably coupled to each of the clamp housing 66 and a portion of the inner housing 48 and that defines a pivot axis. In other embodiments, the clamp housing 66 may be pivotably coupled directly to the outer housing 22. In the illustrated embodiment, the inner housing 48 includes a mount 73 that is integrally formed therewith as a single piece and that defines a bore in which the pin 72 is received. As shown in FIG. 2, the mount 73 is outside the outer housing 22. In some embodiments, the pivot joint 70 may include additional components (e.g., bearings, bushings, etc.) between the mount 73 and the inner housing 48. The pivot joint 70 prevents relative movement between the saw unit 14 and the clamping unit 18 other than a single axis of rotation, thereby limiting relative movement between the saw unit 14 and the clamping unit 18 to a single degree of freedom. Accordingly, when the clamping unit 18 is fixed to a workpiece (e.g., a pipe), the pivot joint 70 restricts the motion of the saw unit 14 such that the saw unit can only pivot about the single pivot axis 75, which is located above the reciprocation axis 50 of the blade 57 from the frame of reference of FIG. 2. Accordingly, the blade 57 will cut through the workpiece along an arc in a plane containing the reciprocation axis 50 of the blade 57.

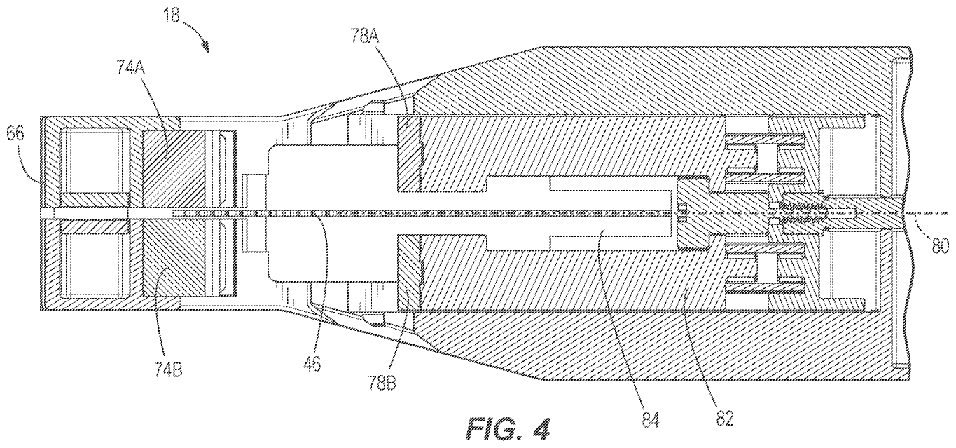

With reference to FIGS. 2 and 4, the clamping unit 18 includes a stationary jaw 74 configured to hold one side of a workpiece. In the illustrated embodiment, the stationary jaw 74 has a V-shape and teeth with which to engage the outer diameter of a piece of pipe. The stationary jaw 74 may be made from metal or another material capable of grasping the workpiece.

With continued reference to FIGS. 2 and 4, the clamping unit 18 also includes a movable jaw 78 slidable within the clamping unit housing 66 towards the stationary jaw 74 along a clamping axis 80, allowing the workpiece to be secured between the stationary jaw 74 and the movable jaw 78. In the illustrated embodiment, the movable jaw 78 is supported upon a jaw carrier 82 in an oblique orientation relative to the clamping axis. The movable jaw 78 includes teeth that are in facing relationship with the teeth on the stationary jaw 74. And, in some embodiments, the movable jaw 78 is movable relative to the jaw carrier 82 to adjust to the shape of the workpiece (if not cylindrical). Like the stationary jaw 74, the movable jaw 78 may be made from metal or another material capable of grasping the workpiece.

With reference to FIG. 4, the stationary jaw 74 may be one of a plurality of stationary jaws 74A, 74B. Similarly, the movable jaw 78 may be one of a plurality of movable jaws 78A, 78B located opposite to the respective stationary jaws 74A, 74B. In some embodiments, the plurality of movable jaws 78A, 78B are coupled together and therefore movable in unison. In other embodiments, each movable jaw 78 of the plurality of movable jaws 78A, 78B may be individually adjustable relative to the clamping axis. In the illustrated embodiment, the at least two stationary jaws 74A, 74B and the at least two movable jaws 78A, 78B form aligned pairs of stationary and movable jaws. Accordingly, a blade slot 84 is formed between the aligned pairs of stationary jaws 74A, 74B, and movable jaws 78A, 78B such that the saw blade 57 may pass between the respective pairs of stationary jaws 74A, 74B and movable jaws 78A, 78B. During operation, the workpiece is clamped between the respective pairs of stationary jaws 74A, 74B and movable jaws 78A, 78B, and subsequently cut by the saw blade 57 creating two separate workpiece portions. Said another way, the first aligned pair of stationary and movable jaws (e.g., 74A, 78A) are disposed adjacent to a first side of the saw blade 57 and the second aligned pair of stationary and movable jaws (e.g., 74B, 78B) are disposed on a second, opposite, side of the saw blade 57. Accordingly, after the cutting operation, each workpiece portion remains clamped to the clamping unit 18 between respective aligned pairs of jaws 74A, 78A and 74B, 78B.

Returning to FIG. 2, the clamping unit 18 includes a ratcheting lead screw mechanism 86 to enable both coarse adjustments and fine adjustments to the position of the movable jaw 78 relative to the stationary jaw 74, and a connecting rod 90 extending between the lead screw mechanism 86 and the movable jaw carrier 82. In some embodiments, the lead screw mechanism 86 may also include a spring (not shown) to bias the movable jaw 78 to a return (i.e., retracted) position. Also, in some embodiments, the lead screw mechanism 86 includes a pawl release 94 operable by a user between an engaged position, in which fine positional adjustments can be made to the movable jaw 78, and a disengaged position, in which coarse positional adjustments can be made to the movable jaw 78, including quickly retracting the movable jaw 78 from the workpiece after a cutting operation is completed to remove the workpiece from the clamping unit 18.

The plane created by the range of motion of the saw blade 46 does not contact the clamping unit 18 due to the clearance provided by the slot 84. Additionally, the rotational arc of the saw blade 46 may be limited to prevent the saw blade 46 from contacting the clamping unit 18. In some embodiments, the inner housing 48 may include a plurality of ball detents (not shown) to hold the saw unit 14 in a first (e.g., parallel) orientation with the clamping unit 18 as shown in FIGS. 1-2, where the workpiece can be secured between the stationary jaw 74 and the movable jaw 78, and a second (e.g., inclined) orientation where the saw blade 46 has cut through the workpiece and is approaching the clamping unit 18. In other embodiments, the saw unit 14 and/or the clamping unit 18 may include a torsion spring to bias the saw unit 14 and the clamping unit 18 towards the first orientation. The saw unit housing 22, the clamp unit housing 66, or the combination of the two may also incorporate stop surfaces to limit the range through which the saw unit 14 may pivot about the pivot joint 70.

Although the invention has been described in detail with reference to certain preferred embodiments, variations and modifications exist within the scope and spirit of one or more independent aspects of the invention as described.

Various features of the invention are set forth in the following claims.

What is claimed is:

1. A reciprocating saw assembly comprising:
a saw unit including
a reciprocating mechanism having a reciprocating spindle to which a saw blade is attachable,
a drive unit for providing torque to the reciprocating mechanism, causing the spindle to reciprocate,
an outer housing in which the drive unit is received and having a handle portion graspable by a user during a cutting operation; and
a clamping unit including
a clamp housing pivotably coupled to the outer housing, and
a jaw movable relative to the clamp housing between a clamping position, in which the clamping unit is affixed to a workpiece to be cut, and a release position, in which the clamping unit is removable from the workpiece.

2. The reciprocating saw assembly of claim 1, wherein a portion of the clamp housing defines a first blade slot configured to receive at least a portion of the saw blade during pivoting movement of the clamping unit relative to the saw unit.

3. The reciprocating saw assembly of claim 2, wherein at least a portion of the jaw defines a second blade slot, and wherein the second blade slot is configured to receive at least a portion of the saw blade during pivoting movement of the clamping unit relative to the saw unit.

4. The reciprocating saw assembly of claim 1, further comprising a pin pivotably coupling the clamp housing to the outer housing.

5. The reciprocating saw assembly of claim 4, wherein the pin defines a pivot axis oriented perpendicular to a reciprocation axis of the reciprocating spindle.

6. The reciprocating saw assembly of claim 4, further comprising an inner housing in which the reciprocating mechanism is at least partially positioned, wherein the inner housing includes a mount to which the pin is pivotably coupled.

7. The reciprocating saw assembly of claim 6, wherein the mount is outside the outer housing.

8. The reciprocating saw assembly of claim 1, wherein the clamping unit further includes a lead screw mechanism configured to enable both coarse adjustments and fine adjustments to a position of the jaw between the clamping position and the release position, and wherein the lead screw mechanism further includes a pawl release operable between an engaged position, in which fine positional adjustments can be made to the jaw, and a disengaged position, in which coarse positional adjustments can be made to the jaw.

9. A reciprocating saw assembly comprising:
a saw unit including
a reciprocating mechanism having a reciprocating spindle,
a saw blade removably coupled to the reciprocating spindle, the saw blade defining a first side and an opposite, second side,
a drive unit for providing torque to the reciprocating mechanism, causing the spindle to reciprocate,
an outer housing in which the drive unit is received and having a handle portion graspable by a user during a cutting operation; and
a clamping unit including
a clamp housing pivotably coupled to the outer housing,
a first stationary jaw affixed to the clamp housing adjacent the first side of the saw blade,
a second stationary jaw affixed to the clamp housing adjacent the second side of the saw blade, and
first and second movable jaws in facing relationship with the first and second stationary jaws, respectively,
wherein the first and second movable jaws are movable in unison relative to the clamp housing between a clamping position, in which the clamping unit is affixed to a workpiece to be cut, and a release position, in which the clamping unit is removable from the workpiece.

10. The reciprocating saw assembly of claim 9, further comprising a pin pivotably coupling the clamp housing to the outer housing.

11. The reciprocating saw assembly of claim 10, wherein the pin defines a pivot axis oriented perpendicular to a reciprocation axis of the reciprocating spindle.

12. The reciprocating saw assembly of claim 10, further comprising an inner housing in which the reciprocating mechanism is at least partially positioned, wherein the inner housing includes a mount to which the pin is pivotably coupled.

13. The reciprocating saw assembly of claim 12, wherein the mount is outside the outer housing.

14. The reciprocating saw assembly of claim 9, wherein the clamping unit further includes a lead screw mechanism configured to enable both coarse adjustments and fine adjustments to a position of the first and second movable jaws between the clamping position and the release position, and wherein the lead screw mechanism further includes a pawl release operable between an engaged position, in which fine positional adjustments can be made to the first and second movable jaws, and a disengaged position, in which coarse positional adjustments can be made to the first and second movable jaws.

15. A reciprocating saw assembly comprising:
a saw unit including
a reciprocating mechanism having a reciprocating spindle to which a saw blade is attachable,
a drive unit for providing torque to the reciprocating mechanism, causing the spindle to reciprocate along a reciprocating axis; and
a clamping unit including
a clamp housing pivotably coupled to the saw unit to be carried therewith,
a first stationary jaw affixed to the clamp housing,
a second stationary jaw affixed to the clamp housing,
first and second movable jaws in facing relationship with the first and second stationary jaws, respectively, and
a blade slot defined between the first and second stationary jaws, and between the first and second movable jaws, wherein the blade slot defines a plane containing the reciprocating axis.

16. The reciprocating saw assembly of claim 15, wherein the saw unit further includes an inner housing in which the reciprocating mechanism is at least partially positioned, and wherein the clamping unit further includes a pin pivotably coupling the clamp housing to the inner housing.

17. The reciprocating saw assembly of claim 16, wherein the pin defines a pivot axis oriented perpendicular to the reciprocating axis of the reciprocating spindle.

18. The reciprocating saw assembly of claim 16, wherein the inner housing includes a mount to which the pin is pivotably coupled.

19. The reciprocating saw assembly of claim 18, wherein the saw unit further includes an outer housing in which at least a portion of the inner housing is received, wherein the outer housing includes a handle portion graspable by a user during a cutting operation, and wherein the mount is outside the outer housing.

20. The reciprocating saw assembly of claim 15, wherein the clamping unit further includes a lead screw mechanism configured to enable both coarse adjustments and fine adjustments to a position of the first and second movable jaws, and wherein the lead screw mechanism further includes a pawl release operable between an engaged position, in which fine positional adjustments can be made to the first and second movable jaws, and a disengaged position, in which coarse positional adjustments can be made to the first and second movable jaws.
